(19) United States
(12) Patent Application Publication
(10) Pub. No.: US 2005/0002028 A1
(43) Pub. Date: Jan. 6, 2005

(54) Time resolved emission spectral analysis system

(76) Inventors: Steven Kasapi, San Francisco, CA (US); Gary Leonard Woods, Sunnyvale, CA (US); John E. Field, Dorrington, CA (US)

Correspondence Address: JOSEPH BACH, 17460 LAKEVIEW DRIVE, MORGAN HILL, CA, 95037, US

(21) Appl. No.: 10/613,592

(22) Filed: Jul. 2, 2003

(51) Int. Cl. G01J 3/30; G01J 3/28

(52) U.S. Cl. 356/328; 356/416

(57) ABSTRACT

A system for temporal and spectral resolved detection of photon emission from an integrated circuit is disclosed. A DUT is stimulated by a conventional ATE, so that its active devices emit light. The signal from the ATE is also sent to the system's computer as a synchronization signal. The light emitted from the switching devices is passed through a wavelength filter. Selected bands of wavelengths are then passed to respective detector(s) and the detector(s) response with respect to the time correlated ATE stimulus is studied.

### BACKGROUND OF THE INVENTION

1. Field of the Invention

The present invention relates to a system for in-situ transistor level measurement of emission spectral and timing information directly related to the switching events (logic transitions) of electrically active semiconductor integrated circuits.

2. Description of the Related Art

It is known in the prior art that various mechanisms in semiconductor devices can cause light emission. Detection of such light emission has been used to investigate semiconductor devices. For example, avalanche breakdown in insulators causes light emission, and detection of such light emission can point to the locations of failure in the device. Similar detection can be used to characterize electrostatic discharge in the device. In electrically stimulated (active) transistors, accelerated carriers (electrons & holes), i.e., hot-carriers, emit light when the device draws current. Various emission microscopes have been used for detecting locations on the device where the electrical current drawn exceeds the expected levels and therefore could lead to locating failures in semiconductor devices. Examples of emission microscopes may be found in U.S. Pat. Nos. 4,680,635; 4,811,090; and 5,475,316.

For transistors, such as those in complementary meal oxide semiconductor (CMOS) devices, the current “pulse” coincides (in-time and characteristics) directly with the voltage transition responsible for the change in the state (logic) of the device. Therefore, resolving in time the hot-electron emissions from electrically active semiconductor transistor devices indicates the behavior and response of the device to electrical currents and the temporal relations of the current pulses with respect to each other. These temporal characteristics, along with the detection of the transition (pulse) itself, are of critical importance in the design and debug of integrated circuit (IC) devices. Related works on the subject have been published and represented by the following papers:

All-Solid-State Microscope-Based System for Picosecond Time-Resolved Photoluminescence Measurements on II-VI semiconductors, G. S. Buller et al., Rev. Sci. Instrum. pp.2994, 63, (5), (1992);
Time-Resolved Photoluminescence Measurements in InGaAs/InP Multiple-Quantum-Well Structures at 1.3-m Wavelengths by Use of Germanium Single-Photon Avalanche Photodiodes, G. S. Buller et al., Applied Optics, Vol 35 No. 6, (1996);
Analysis of Product Hot Electron Problems by Gated Emission Microscope, Khurana et al., IEEE/IRPS (1986);
Ultrafast Microchannel Plate Photomultiplier, H. Kume et al., Appl. Optics, Vol 27, No. 6, 15 (1988); and
Two-Dimensional Time-Resolved Imaging with 100-ps Resolution Using a Resistive Anode Photomultiplier Tube, S. Charboneau, et al., Rev. Sci. Instrum. 63 (11), (1992).
Dynamic Internal Testing of CMOS Circuits Using Hot Luminescence, J. A. Kash and J. C. Tsang, IEEE Electron Device Letters, vol. 18, pp. 330-332, 1997.

Notably, Khurana et al., demonstrated that photoluminescence hot-carrier emission coincides in time and characteristics with the current pulse and thereby the voltage switching of a transistor, thereby teaching that, in addition to failure analysis (location of “hot-spots” where the device may be drawing current in excess of its design), the phenomenon can also be used for obtaining circuit timing information (switching) and therefore used for IC device debug and circuit design. See, also, U.S. Pat. No. 5,940,545 to Kash et al., disclosing a system for such an investigation. For more information about a time-resolved photon emission system the reader is directed to U.S. patent application Ser. No. 09/995,548, commonly assigned to the current assignee and incorporated herein by reference in its entirety. Such system is commercially available under the trademark EmiScope® from assignee, Optonics Inc., of Mountain View, Calif.

FIG. 1A is a block diagram depicting an arrangement of a conventional time resolved emission system. A device under test (DUT) 110 is being stimulated by stimulus 120, e.g., a conventional automated testing equipment (ATE 305 in FIG. 3). The ATE also sends a start signal to the time-to-digital converter 180, so that it is synchronized therewith. When the DUT emits light in response to the stimulus 120, the light is detected by detector 150, which then sends a signal to the time-to-digital converter 180, so that the timing of the emission can be determined.

FIG. 1B is a block diagram of a conventional spectroscopy system. An example of such a system is disclosed in U.S. Pat. No. 6,429,968, which is incorporated herein by reference in its entirety. A DUT 110′ is illuminated by illumination source 120′. Light reflected from the DUT is then passed through a wavelength filter 140′, e.g., a grating, and a desired wavelength is sent to the detector 150′ to generate a detection signal. In this manner, the response characteristics of the DUT at a particular wavelength can be studied. A similar system is also disclosed in U.S. Pat. No. 5,661,520.

As the complexity of integrated circuits increases, new methods of investigating and characterizing their function and failure modes are needed.

### SUMMARY OF THE INVENTION

The present invention provides a novel method for characterizing semiconductor circuits' operation and failure modes using a novel technique for time-correlated spectral analysis of emitted photons. A DUT is stimulated by a conventional ATE, and its active devices emit light. The signal from the ATE is also sent to the system's computer as a synchronization signal. The light emitted from the switching devices is passed through a wavelength selective device such as a band pass optical filter, grating monochrometer, or Fourier transform interferometer. A band of wavelengths are then passed to respective detector or detectors, and the detectors response or responses with respect to time-correlated ATE stimulus is recorded.

In one aspect of the invention, an integrated system for testing an integrated circuit chip is provided. The chip under test is coupled to automated test equipment (ATE) that powers the device and electrically stimulates it with programmed logic vectors and signals to simulate operating (functional and test) conditions of the chip. The inventive system comprises a controller receiving sync signals from the ATE; a wavelength discrimination arrangement for spectrally resolving light collected from the chip; a light detector detecting the light from the filter and providing a signal indicative of the photoemissions at a selected wavelength to the controller, so as to provide a time-correlated emission at a selected wavelength.

In another aspect of the invention, the inventive system comprises an x-y-z stage that is used to move the optics to the location of interest on the device under test, and focus and image the device(s) of interest. The navigation is performed in relation to a CAD layout of the IC. A mechanized shutter is used to variably define imaging areas within the field of view of the optics. During navigation and target acquisition, the device is illuminated and is imaged with an imaging array, thereby providing high spatial resolution. When a device to be tested has been aligned, i.e., placed within the imaging area, the illumination source is turned off and the device is electrically stimulated with test signals. During the stimulation period, hot electron photon emission, as well as photon emission from other sources such as hot holes, gate leakage, and oxide tunneling, is collected by the optics and is imaged onto the core of a multimode optical fiber. The collected light is filtered to a predefined optical bandwidth before it is sensed by a detector, thereby providing spectral resolution.

To provide the temporal resolution, emission detection is synchronized with the test signals, i.e., the automated test equipment (ATE). The detector is coupled to a time-resolved photon counting detector, such as one comprising an avalanche quenching circuit, a time-to-amplitude converter (TAC), and a multi-channel analyzer. Optionally, the APD is gated so that it assumes the detection condition only just before a light emission is expected according to the sync signal from the ATE. This provides reduction in noise.

### BRIEF DESCRIPTION OF THE DRAWINGS

The invention is described herein with reference to particular embodiments thereof, which are exemplified in the drawings. It should be understood, however, that the various embodiments depicted in the drawings are only exemplary and may not limit the invention as defined in the appended claims.

FIGS. 1A and 1B are block diagrams of prior art systems for investigation of semiconductor circuits.

FIG. 2 is a block diagram of the major components of a system according to an embodiment of the present invention.

FIG. 3 is a general schematic depicting the major components of the system according to an embodiment of the invention.

FIG. 4a is a more detailed schematic depicting various components of the system according to an embodiment of the invention; while FIG. 4b is s detailed schematic of another embodiment of the invention.

FIG. 5 is a general schematic depicting the major components of the system according to an embodiment of the invention.

FIG. 6a is a general schematic depicting an embodiment of the present invention utilizing a filter; while FIG. 6b is a general schematic of an embodiment of the invention using a spectrometer.

FIG. 7 is a graph exemplifying a frequency response of a detector and filter according to an embodiment of the invention.

FIG. 8 is a block diagram exemplifying a high-speed time resolved emission detection scheme according to an embodiment of the present invention.

FIG. 9 is a general schematic depicting an embodiment of the present invention utilizing a spatially dispersive element and a spatial detector.

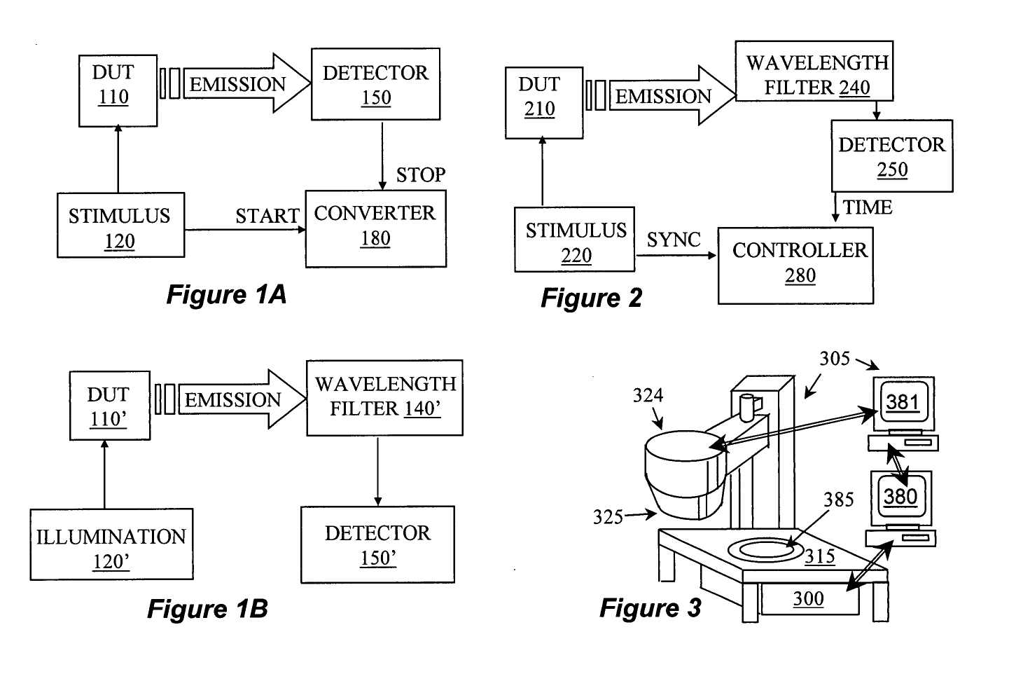

### DETAILED DESCRIPTION

The present invention provides a testing and debug system particularly suitable for rise time, timing, logic fault localization, and other testing of microchips. The investigation is performed with respect to a time correlation to electrical stimulus provided to the DUT, and with respect to the wavelength of the light emitted from the DUT. FIG. 2 is a block diagram depicting the major components of the system according to an embodiment of the invention. The ATE 220 electrically stimulates the DUT 210, and also sends a sync signal to the controller 280. In response to the stimulus, DUT 210 provides optical emission, which is made to pass through a wavelength filter 240. Selected wavelengths pass through the filter 240 and are directed to detector 250. The signal from the detector 250 is sent to the controller 280. Consequently, the system provides temporal and spectral resolution of optical emission of the DUT.

By studying time-correlated emission at particular wavelengths one can decouple background events from switching events. Additionally it is possible to study the transient thermal behavior of the device by investigating the thermal and hot electron emission. A further potential study is separating the various emission mechanisms and their temporal evolution. For example, electron-hole recombination would produce photons at wavelength near the silicon bandgap (attributable to substrate current), whereas scattering events would produce photons of longer wavelengths.

FIG. 3 depicts the general elements of the system, as it is coupled to a commercially available ATE 305. The ATE 305 generally comprises a controller, such as a pre-programmed computer 381, and a test head 324, which comprises an adapter 325 used to deliver signals programmed by the controller 381 to the DUT (not shown) in a manner well known in the art. Specifically, the ATE is used to generate signals that stimulate the DUT to perform various tasks, as designed by the chip designer to check and/or debug the chip. The various signals generated by the controller test head 324 are programmed by the controller 381 and are delivered by the test head 324 to the DUT via the adapter 325. The adapter 325 may include a space transformer, a DUT load board and a DUT socket, in a manner well known in the art.

In the embodiment depicted in FIG. 3, the ATE test head 324 is placed over opening 385 on the top of a vibration isolated bench 315. Chamber 300 houses the main components of the diagnostic system, and is situated below, so that once the ATE head 324 is connected to the system, no external light can reach the elements inside chamber 300. The diagnostic system is controlled by controller 380, such as a pre-programmed general-purpose computer, which also communicates with the ATE controller 381.

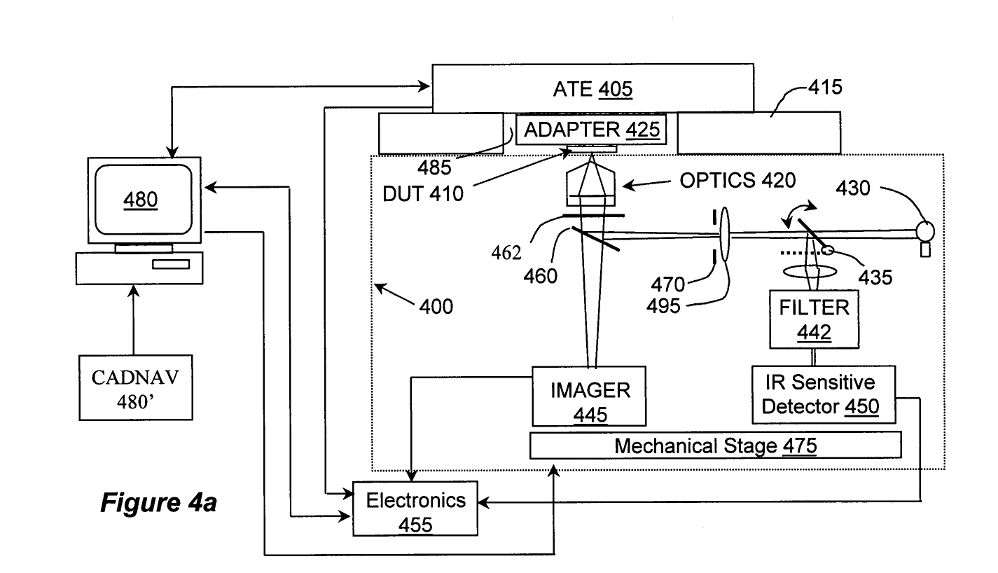

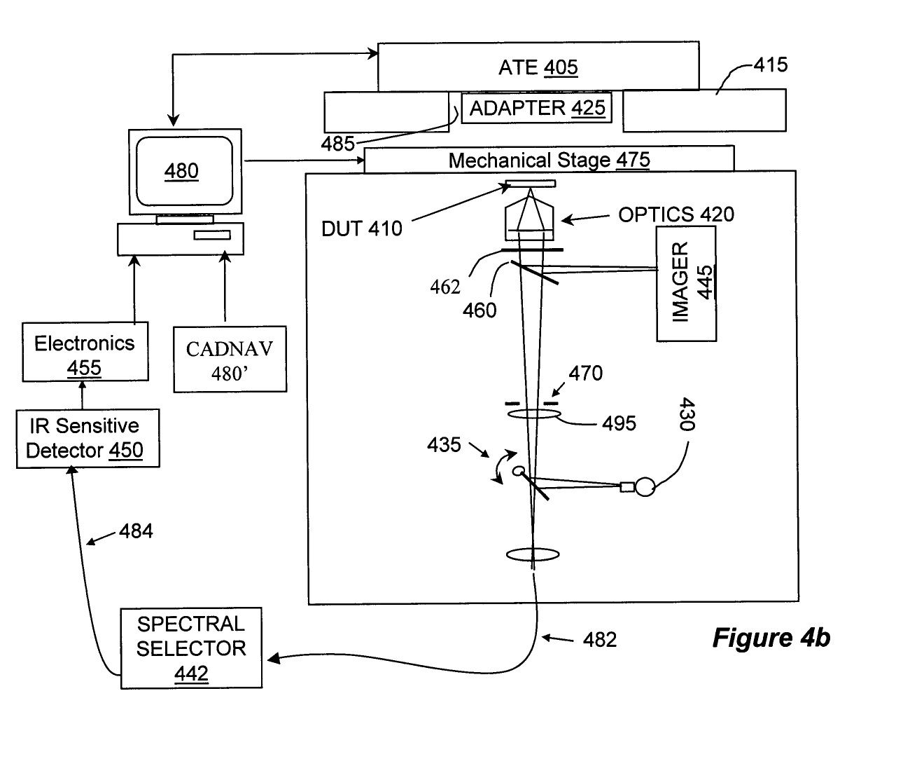

FIG. 4a is a detailed diagram of an embodiment of the testing system that may be situated inside chamber 300 of FIG. 3. That is, ATE head 405 is provided with an adapter 425 having a DUT 410 attached thereto. The ATE head 405 is placed on top of the bench 415 so as to expose the DUT 410 via the opening 485. In this particular example, a single controller 480 is provided to control both the ATE and the diagnostic system; however, it should be readily apparent that any combination of controllers and or computers may be used for the ATE and the diagnostic system. Similarly, the DUT stimulation section may also be a part of the diagnostic system.

The controller 480 communicates with the various elements inside the chamber 400 via electronics section 455. Additionally, information about the DUT design and layout can be imported from a CAD software, such as, for example, Cadence™. Then, using navigation software, such as, for example, Merlin's Framework available from Knights Technology of San Jose, Calif. (www.electroglas.com), one may select a particular device for emission testing, as will be explained more fully below.

The particular diagnostic system depicted in FIG. 4a includes two parts, enabling the system to operate in an imaging or a detection mode. Therefore, the various elements of the diagnostic system will be described with reference to their operation in the imaging and detection modes. The modes are switched by positioning the mirror 435 in the illumination path (shown in solid) for detection mode, or out of the illumination path (shown in dotted) for imaging mode. In the imaging mode, an illumination source 430 is used to illuminate the DUT 410; mirror 435 being swung out of the illumination path as shown in dotted line. Illumination source 430 emits light in the infrared (IR) range using, for example, an IR laser, a light emitting photodiode, or a tungsten-halogen lamp with a long-pass filter. The light is focused through the microscope optics 420 onto, and then reflects from, the DUT 410. The light reflecting from the DUT 410 passes through the partial-mirror 460 and reaches imager 445. In one embodiment, the collection optics include a solid immersion lens such as described in, for example, U.S. Pat. Nos. 5,004,307, 5,208,648, and 5,282,088, which are incorporated herein by reference in their entirety. More specifically, the immersion lens may be a bi-convex immersion lens as described in U.S. application Ser. No. 10/052,011, commonly assigned to the present assignee and incorporated herein by reference in its entirety.

The imager 445 can be any two-dimensional detector capable of imaging in the infrared range, such as, for example, an infrared sensitive vidicon camera, or InGaAs array. IR vidicon cameras are commercially available from, for example, Hamamatsu Corporation of New Jersey (http://usa.hamamatsu.com). In this example the device of interest is fabricated on silicon. As is well known, wavelengths shorter than IR are absorbed in silicon. Therefore, in this example the illumination and imaging is done in the infra-red region of the spectrum, between approximately 1.0 and 1.5 microns. Of course, if the device of interest is fabricated on a different substrate, such GaAs, a different wavelength illumination and imaging may be used. Thus, in this mode, the DUT 410 is illuminated and an image of an area of interest on the DUT may be obtained.

In the detection mode, light source 430 is turned off and the mirror 435 is swung into the illumination path as depicted in solid line. The DUT 410 is then electrically stimulated by the ATE and light emitted from the DUT is reflected by partial mirror 460 and mirror 435 onto filter 442. In one embodiment the partial mirror 460 comprises a pellicle (i.e., a very thin beamsplitter) so as to avoid deleterious effects on the beam. Filter 442 may be such as disclosed in, for example, U.S. Pat. Nos. 5,721,613 and 5,995,235, which are incorporated herein by reference in their entirety. The filter 442 provides the light output at selected wavelengths, which are then detected by one or more detectors 450 which, in this case, are IR sensitive. Example of a particularly suitable detector is an avalanche photodiode (APD) operated in the Geiger mode or a photon-counting photomultiplier tube. Using the sync or the DUT stimulus signal and the output of the detector 450, the system provides spectrally and temporally resolved emission signals.

An optional feature of the system of FIG. 4a is a mechanized aperture 470 and field lens 495, provided at the image plane of the collection optics 420. Notably, in this embodiment the entrance pupil of collection optics 420 is imaged by the field lens 495 onto the entrance plane of the focusing element of the detector in imager 445. In one implementation (not depicted here) the pupil entrance of the collection optics is imaged by the focusing element onto a fiber, which couples the collected photons into the detector in imager 445. A feature of this embodiment is that the illumination path takes place through the mechanized aperture 470 (which is positioned at the image plane of the collection optics) and thereby its opening defines the filed-of-view on the sample or device under test. The aperture also defines the portions of the sample imaged onto the imager 445. That is, depending on the particular test to be run, one may wish to select any particular section of the DUT for emission. Using information about the chip design and layout stored in the CAD software, one may select a particular device for emission measurements, and block the image and hence the emission of the other devices outside the field-of-view of the collection optics. When the user selects a device or location from which to collect photons, the system activates the stage 475 so that the collection optics is centered on the selected device or location. Alternatively, as long as the area of interest is in the field-of-view of the collection optics, one can isolate the area of interest with the apertures and proceed to image and detect “selectively.” The aperture 470 may be adjusted to increase or decrease the field of view as appropriate for the particular test desired.

FIG. 4b is a schematic of another embodiment of the invention. Elements similar to those found in the embodiment of FIG. 4a are identified with the same reference numerals. As depicted in FIG. 4b, according to this embodiment of the invention emission detection is performed on “line of sight,” while illumination and imaging are performed “off axis.” Also, in this embodiment multimode fibers 482, 484 are used to transmit the light to the detector 450. In this particular example, a spectral selector 442 is inserted between multimode fibers 482 and 484. The spectral selector 442 may be of any of the spectral filters disclosed and envisioned by this disclosure.

Another embodiment of the inventive system is depicted in FIG. 5. Again, the system may be thought of as an imaging part 500 and a detection part 555. Switching between the imaging part 500 and detection part 555 is achieved by flipping the mirror 535. The imaging part is active when the mirror is positioned as noted in solid line, while detection is performed when the mirror is position as noted in the dotted line. The imaging part includes a light source 530, illuminating the DUT via lenses 510, 515, mirrors 505 and 535, and collection optics 520. Reflected light collected from the DUT by collection optics 520 is directed to the imager 545 by half mirror 525. In this embodiment, collection optics 520 includes an optional solid immersion lens 522. One benefit of using a bi-convex solid immersion lens is the ability to “press” with minimum force the immersion lens into the DUT to avoid having an air-gap between the immersion lens and the DUT. Another advantage is that it allows for easier lateral movement over the DUT, since it avoids vacuum conditions with the DUT.

On the other hand, during testing, the light source 530 is turned off and mirror 535 is swung to the position noted by a dotted line. When the DUT is stimulated, light emitted by the DUT is collected by objective 520 and is deflected by mirror 535 through lens 540 into fiber 560, via fiber coupler 550. The light exiting the fiber 560 passes through collimating lens 565 and the collimated light is reflected off a grating 575. The reflected light passes through focusing lens 580 to collected onto the core of the multimode fiber. However, since the first order reflection angle from the grating is wavelength dependent, various wavelengths passing through focusing lens 580 would be focused at different transverse spatial locations. So, for example, if only two wavelengths are of interest, one may be focused at a location as shown in a solid line, while the other may be focused as shown in a broken line. To collect the two wavelengths separately, two detectors 590, 590′ may be used as exemplified in FIG. 5. That is, a first wavelength is collected into fiber 585 and is detected by detector 590, while a second wavelength is directed into fiber 585′ and is detected by detector 590′. As can be appreciated, if more wavelengths are of interest, additional fibers with corresponding detectors may be added. In this manner, emissions at all wavelengths of interest may be detected simultaneously.

Alternatively, a single fiber with a single detector may be used to detect emissions at various wavelength by simply moving the fiber. This is exemplified in FIG. 5 by the large broken arrow 595. For example, assuming only fiber 585 and detector 590 are provided, at a first time period the fiber 585 is situated at a location so as to collect emission at a wavelength depicted in solid lines. Then, at a second period, the fiber is moved as shown by the broken arrow, so that it collect light at a wavelength depicted in a broken line. Of course, the fiber may be moved to many locations to collect light at many other wavelengths.

Alternatively, the fiber may remain stationary while the grating is rotated to couple light centered at different wavelengths into the core of the fiber. The fiber may be mounted on a manual or motorized rotation stage to select the wavelength of interest.

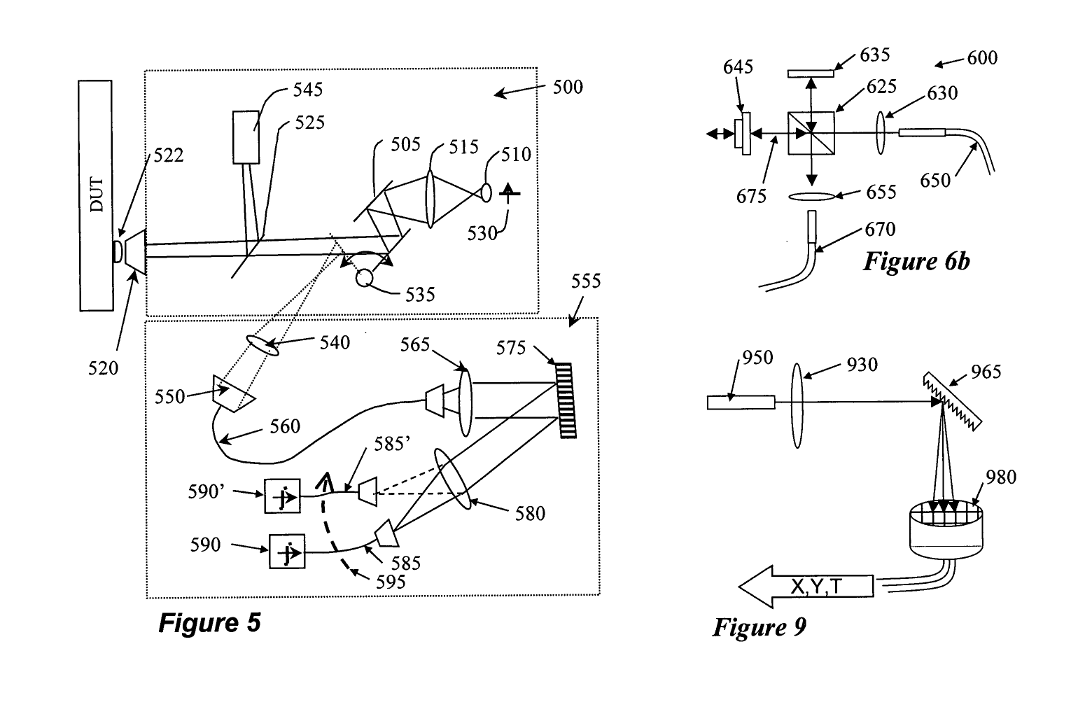

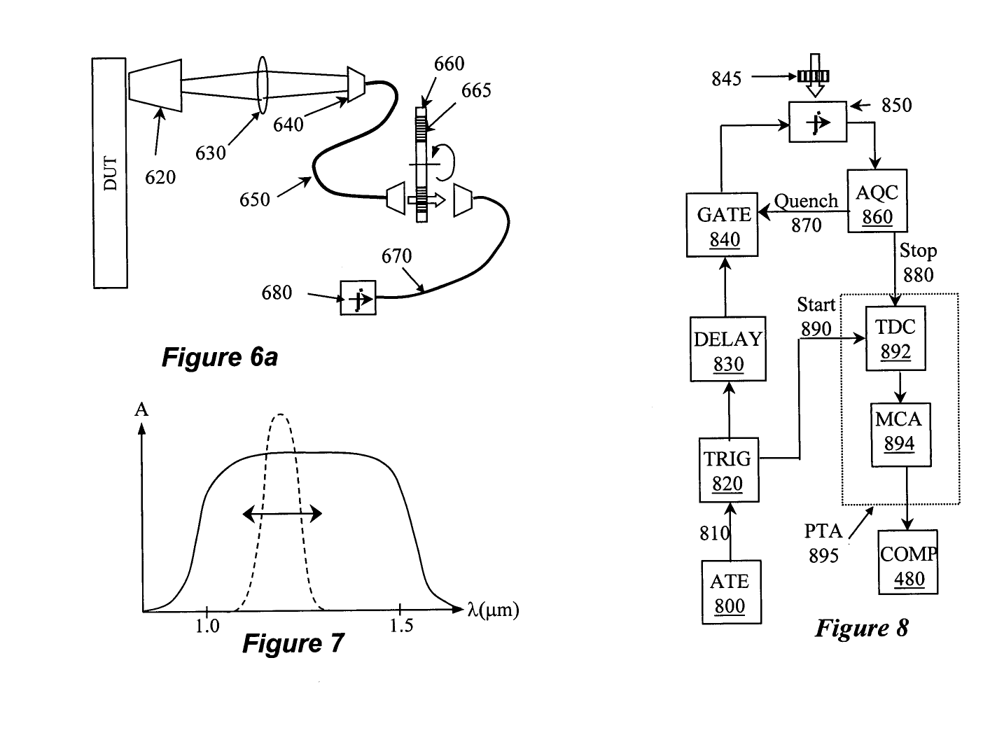

FIG. 6a depicts yet another embodiment of the invention. In this embodiment, light emitted from the DUT is collected by the objective optics 620, and is directed into fiber collector 640 via optics/lens 630. The light is transmitted in fiber 650 and is then passed through one of the several filters 665, positioned on filter wheel 660. Filter wheel 660 can be rotated to position various filters 665 in the light path, as shown by the curved arrow. The filtered light is then colleted by fiber 670, and is detected by detector 680, such as an APD.

FIG. 6b depicts still another embodiment of the invention. The photons emitted by the device under test are coupled into the multimode fiber 650′ as in the previous embodiments. At the other end of the multimode fiber the photons are collimated by collimating lens 630 and coupled into a Fourier-transform infra-red spectrometer 600, such as Model MIR 8000™ produced by Oriel Instruments of Stratford, Conn., and is well known to those skilled in the art. Fourier transform infra red spectrometers are well known for spectral analysis of light with very weak intensity and are commonly used in chemical and biological spectroscopy. The spectrometer comprises a semi-transparent double mirror 625, a fixed mirror 635, and a scanning mirror 645. A collimating lens 655 collects the light output by the spectrometer 600 and couples it into output fiber. In operation, the scanning mirror 645 is variably scanned so that the length of path 675 is changed for collecting selected frequency band. The resulting photon counting signal for each path length is recorded. In this way the full spectrum of the emission can be recorded in time. The advantage of the Fourier transform spectrometer is that it discards fewer photons than the grating or the selective filter embodiments. It does, however, require more sophisticated signal processing.

FIG. 7 depicts a graph to exemplify the operation of any of the above noted embodiments. The x-axis is wavelength, while the y-axis is amplitude (in arbitrary units). The response of the detector is exemplified by the solid curve. In this example, the detector is sensitive in the wavelengths of about 1-1.5 μm. The filtering response, on the other hand, is much narrower and is depicted by the broken curve. Thus, for example, each of the various filters 665 of FIG. 6 can have a similar narrow response band, but centered at a different wavelength. Thus, by changing the filters, one can scan the entire bandwidth of the detector by slices of sufficiently narrow frequency bands. Similarly, by using detectors at different locations, as shown in FIG. 5, one may cover the entire bandwidth of the detector using sufficiently narrow bands of wavelengths.

FIG. 8 exemplifies a high-speed time resolved emission detection scheme according to an embodiment of the present invention using a gated time-resolved photon counting detector. Specifically, in this example the detector is a gated InGaAs detector operating in the Geiger mode. Specifically, ATE 800 generates a trigger signal 810, which is sent to a triggering circuit 820. Triggering circuit 820 enables triggering on either the rising or falling edge of the trigger signal 810, with a selectable amplitude, e.g., in the range of −2.5 to +2.5 Volts. When the appropriate triggering conditions have been detected, triggering circuit 820 generates a high-speed “START” signal 890, which defines the beginning of an acquisition sequence. The triggering circuit 820 also provides a signal to a delay generation circuit 830, which waits a user-selectable amount of time before issuing a signal to gating circuitry 840. Gating circuitry 840 is used to gate detector 850 on and off. The gating circuitry 840 gates on detector 850, at which point it can detect individual photons passing through filtering mechanism 845. Detector 850 remains gated on according to a user-selectable period of time as determined by the delay generation circuitry 830, but detector 850 can be actively quenched, i.e. gated off, if acquisition circuitry (ACQ) 860 determines that a photon has been detected by detector 850. Specifically, AQC 860 monitors detector 850 for photon detection, and if a photon is detected AQC 860 sends two signals; the first signal, Quench 870, instructs the gating circuitry to gate off detector 850, while the second signal is a high-speed “STOP” signal 880 which defines the photon arrival time at the detector. Thus, if a photon is detected by detector 850, the Quench signal 870 will instruct the gating circuitry 840 to gate off detector 840 before the delay circuitry 830 would otherwise have caused gating circuitry 840 to gate off the detector 840.

The “START” 890 and “STOP” 880 signals are used by the Picosecond Timing Analyzer (PTA) 895, which is a commercial test instrument. PTA 895 comprises a time-to-digital converter (TDC) 892 and a multichannel analyzer (MCA) 894, which forms a histogram of the photon event times during a data acquisition sequence. The histogram is transferred to the computer 480 through the PTA electrical interface (not shown).

FIG. 9 shows yet another embodiment of the system, using either a photon counting linear array or a time resolved imaging detector such as that produced by Quantar Technologies of Santa Cruz, Calif. In this embodiment, the light from an isolated emitting device in the DUT is passed through a spectrally dispersive element 965, such as a grating or a prism, and is imaged onto the detector array 980. In one example the dispersive element 965 is a grating that is moveable in angular orientation and spatial position. The lateral position of the detected photon corresponds to a particular wavelength. By recording both the position (X,Y,) and the time of arrival (T) of the photons on the detector array, both the temporal and spectral information in the photon stream can recorded. As shown in this embodiment, the light collected from the DUT is transmitted using fiber optic 950 and is collimated onto the dispersive element 965 by collimating lens 930.

While the invention has been described with reference to particular embodiments thereof, it is not limited to those embodiments. Specifically, various variations and modifications may be implemented by those of ordinary skill in the art without departing from the invention's spirit and scope, as defined by the appended claims. Additionally, all of the above-cited prior art references are incorporated herein by reference.

1. An integrated system for testing a photon emitting device, said device stimulated temporally, comprising:
a test bench for placing the device thereupon;
an adapter for coupling electrically stimulating signals to said device;
collection optics for collecting photons emitted from said device in response to said stimulating signals;
a spectrally selective element for spectrally selecting said photons;
a time-resolved photon sensor for detecting said photons;
a timing mechanism for timing the sensor detection of said photons.

2. The system of claim 1, wherein said spectrally selective element comprises a filter.

3. The system of claim 1, wherein said spectrally selective element comprises a grating.

4. The system of claim 1, wherein said spectrally selective element comprises a plurality of filters, each filter providing a pre-determined spectral band.

5. The system of claim 1, wherein said spectrally selective element comprises a Fourier-transform spectrometer.

6. The system of claim 1, wherein said photon sensor comprises a detector array, and wherein said spectrally selective element spatially disperses the spectral bandwidth so that each pre-determined spectral bandwidth impinges on a predetermined location of said detector array.

7. The system of claim 3, wherein said photon sensor comprises a plurality of photon detectors.

8. The system of claim 3, wherein said photon sensor is movable spatially.

9. The system of claim 3, wherein said photon sensor is a two dimensional detector.

10. The system of claim 3, wherein the grating is moveable, both in angular orientation and spatial position.

11. The system of claim 4, wherein each of said filters is selectably insertable into the optical path of said photon detector.

12. The system of claim 11, wherein said plurality of filters are provided on a rotating filter wheel.

13. The system of claim 1, further comprising a solid immersion lens (SIL).

14. The system of claim 13, wherein said SIL is bi-convex.

15. An integrated system for testing a photon emitting device, said device stimulated temporally, comprising:
a test bench structured to mounting the device thereupon;
an adapter enabling coupling of electrically stimulating signals to said device;
collection optics situated to collect photons emitted from said device in response to said stimulating signals;
multimode fiber coupled to said collection optics to thereby receive the collected photons;
a spectrally selective element providing spectral selection of said photons;
a time-resolved photon sensor for detecting said photons;
a timing mechanism for timing the sensor's detection of said photons.

16. The system of claim 15, wherein said spectrally selective element comprises one of: a filter, a grating, and a Fourier-transform spectrometer.

17. A method for testing a photon emitting device, comprising:
temporally stimulating said device so as to cause said device to emit photons;
collecting said photons emitted from said device;
spectrally separating said photons; and
time-resolving said photons to thereby provide emission timing of photons at separate spectral frequency.
